(19) United States
(12) Patent Application Publication
(10) Pub. No.: US 2024/0425391 A1
(43) Pub. Date: Dec. 26, 2024

(54) REMOVAL OF CONTAMINANTS USING PHOTOELECTROCATALYSIS

(71) Applicant: Regents of the University of Minnesota, Minneapolis, MN (US)

(72) Inventors: Tianhong Cui, Minneapolis, MN (US); Peng Zhou, Minneapolis, MN (US)

(21) Appl. No.: 18/745,149

(22) Filed: Jun. 17, 2024

Related U.S. Application Data
(60) Provisional application No. 63/522,625, filed on Jun. 22, 2023.

(51) Int. Cl. C02F 1/461; C02F 1/32; C02F 1/467; C02F 1/62; C02F 101/20; C02F 101/30

(52) U.S. Cl. CPC C02F 1/46109; C02F 1/32; C02F 1/4672; C02F 1/4678; C02F 1/62; C02F 2001/46142; C02F 2101/20; C02F 2101/308; C02F 2305/10

(57) ABSTRACT

The present document relates to systems that employ photoelectrocatalysis, as well as methods using photoclectrocatalysis. In particular, the systems and methods can provide improved removal of contaminants from water.

### CROSS-REFERENCE TO RELATED APPLICATIONS

This application claims the benefit of U.S. Patent Application Ser. No. 63/522,625, filed on Jun. 22, 2023. The disclosure of the prior application is considered part of, and is incorporated by reference in, the disclosure of this application.

### FIELD

The present document relates to systems and methods that employ photoelectrocatalysis. In particular, the systems and methods can provide improved removal of contaminants from water.

### BACKGROUND

Removal of contaminants from water can employ various strategies. Optimal strategies could allow for improved removal of differing types of contaminants in an effective and sustainable manner.

### SUMMARY

The present document relates to systems that employ photoelectrocatalysis for treating water. In particular, the systems herein employ photoelectrocatalysis to remove both organic and inorganic contaminants. Furthermore, described herein are improved configurations of electrodes within a photoelectrocatalysis system to allow for improved removal.

Accordingly, in some aspects, the present document encompasses a system for removing one or more contaminants, the system comprising: a counter electrode comprising a photocatalyst; a working electrode comprising a conductive material; and a fluidic cell configured to provide a fluid in proximity to the counter electrode and the working electrode. In some embodiments, the system is configured to perform reverse photoelectrocatalysis.

In some embodiments, the system further comprises a reference electrode. In some embodiments, the system is configured to provide an applied potential (e.g., an applied negative potential) between the working electrode and the reference electrode.

In some embodiments, the system further comprises: a polymeric layer (e.g., comprising fluorinated ethylene propylene polymer or polystyrene polymer) disposed on at least a portion of a second surface of the substrate, wherein the second surface opposes the first surface; and an optional adhesive layer disposed between the substrate and the polymeric layer.

In one aspect, the present document encompasses a system for removing one or more contaminants, the system comprising: a substrate comprising a first surface and a second surface that opposes the first surface; a counter electrode comprising a photocatalyst, wherein the counter electrode is disposed on at least a portion of the first surface of the substrate; a working electrode comprising a conductive material, wherein the working electrode is disposed on at least a portion of the first surface of the substrate; a reference electrode disposed on at least a portion of the first surface of the substrate; a fluidic cell disposed on at least a portion of the first surface of the substrate; and a radiation source configured to provide radiation to the photocatalyst (e.g., through the first surface or the second surface of the substrate).

In some embodiments, the system is configured to perform reverse photoelectrocatalysis.

In some embodiments, the fluidic cell is configured to provide a fluid in proximity to the counter electrode, the working electrode, and the reference electrode.

In some embodiments, the radiation source is configured to provide ultraviolet (UV) radiation (e.g., having from about 280 to 400 nm).

In some embodiments, the system further comprises: a polymeric layer (e.g., comprising an ultraviolet transparent polymer) disposed on at least a portion of the second surface of the substrate, wherein the polymeric layer is configured to receive and transmit radiation from the radiation source to the photocatalyst; and an optional adhesive layer disposed between the substrate and the polymeric layer.

In one aspect, the present document encompasses a method for treating a contaminated fluid. In some embodiments, the method comprises: subjecting the contaminated fluid to reverse photoelectrocatalysis by employing a counter electrode comprising a photocatalyst and a working electrode comprising a conductive material, thereby removing at least one organic contaminant and at least one inorganic contaminant from the contaminated fluid.

In some embodiments, said subjecting comprises: delivering the contaminated fluid to a counter electrode comprising a photocatalyst, a working electrode comprising a conductive material, and an optional reference electrode. In some embodiments, said delivering further comprises providing the contaminated fluid to a microchannel, wherein the counter electrode is disposed within the microchannel.

In some embodiments, said subjecting further comprises (e.g., after said delivering): providing an applied potential (e.g., an applied negative potential) between the working electrode and the reference electrode.

In some embodiments, said subjecting is performed in any system described herein.

In any embodiment herein, the photocatalyst comprises titanium dioxide. In some embodiments, the titanium dioxide is provided within a layer (e.g., a single layer, a bilayer, or a multilayer) further comprising a polymer (e.g., an anionic polymer). In some embodiments, the titanium dioxide is provided within a bilayer further comprising a polymer (e.g., an anionic polymer).

In any embodiment herein, the photocatalyst comprises a plurality of layers (e.g., 1, 2, 3, 4, 5, 6, 7, 8, 9, 10, or more layers) or a plurality of bilayers (e.g., 1, 2, 3, 4, 5, or more bilayers. In some embodiment, a first layer of the bilayer comprises titanium dioxide and a second layer of the bilayer comprises a polymer).

In any embodiment herein, the working electrode comprises graphene, graphene oxide, graphite, or graphite oxide (e.g., which may optionally be disposed on a substrate, e.g., a metal substrate, such as in a graphene oxide-coated metal).

In any embodiment herein, the fluidic cell comprises a microchannel, an inlet in fluidic communication with the microchannel and configured to deliver the fluid as an input into the microchannel, and an outlet in fluidic communication with the microchannel and configured to deliver the fluid as an output out of the microchannel. In some embodiments, the counter electrode is disposed within the microchannel. In some embodiments, the counter electrode, the working electrode, and the reference electrode are disposed within the microchannel. In some embodiments, the microchannel is configured to provide fluidic communication between the counter electrode and the working electrode. In some embodiments, the microchannel is configured to provide fluidic communication between the counter electrode, the working electrode, and the reference electrode.

In any embodiment herein, the counter electrode, the working electrode, the fluidic cell, and/or the reference electrode is disposed on at least a portion of a first surface of a substrate (e.g., a flexible substrate or a curved substrate).

In any embodiment herein, a contaminant can include at least one organic contaminant and/or at least one inorganic contaminant. In some embodiments, the contaminant comprises a dye, a metal (e.g., a heavy metal), or a metal ion (e.g., a heavy metal ion). Additional details follow.

### Definitions

As used herein, the term “about” means +/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the system.

By “fluidic communication,” as used herein, refers to any duct, channel, tube, pipe, chamber, or pathway through which a substance, such as a liquid, gas, or solid may pass substantially unrestricted when the pathway is open. When the pathway is closed, the substance is substantially restricted from passing through. Typically, limited diffusion of a substance through the material of a device, platform, platen, layer, and/or a substrate, which may or may not occur depending on the compositions of the substance and materials, does not constitute fluidic communication.

By “microfluidic” or “micro” is meant having at least one dimension that is less than 1 mm. For instance, a microfluidic structure (e.g., any structure described herein) can have a length, width, height, cross-sectional dimension, circumference, radius (e.g., external or internal radius), or diameter that is less than 1 mm.

Other features and advantages of the present document will be apparent from the following detailed description, the figures, and the claims.

### BRIEF DESCRIPTION OF THE DRAWINGS

The following drawings illustrate certain embodiments of the features and advantages of this document. These embodiments are not intended to limit the scope of the appended claims in any manner. Like reference symbols in the drawings indicate like elements.

FIG. 1A-1B shows a schematic of non-limiting systems for performing photoelectrocatalysis (PEC). Provided are (A) a non-limiting schematic including a working electrode and a counter electrode and (B) a non-limiting schematic including a working electrode, a counter electrode, and a reference electrode.

FIG. 2A-2C shows non-limiting miniaturized system for performing PEC. Provided are (A) a schematic of a non-limiting miniaturized microfluidic PEC water purification system; (B) a schematic of a non-limiting fabrication process; and (C) an image of a non-limiting fabricated chip PEC system without the microchannel.

FIG. 3 shows a schematic depicting a non-limiting example of a layer-by-layer process.

FIG. 4 shows a schematic of a non-limiting experimental setup for conducting photoelectrocatalytic water purification tests.

FIG. 5 shows scanning electron microscopy (SEM) images of a non-limiting photocatalyst before and after annealing at 500° C. Provided are images of (a) 8 bilayers of poly(sodium 4-styrenesulfonate) (PSS) TiO₂ on a glass substrate before annealing, low resolution; (b) 8 PSS/TiO₂ bilayers on a glass substrate before annealing, high resolution; (c) 8 PSS/TiO₂ bilayers on a glass substrate after annealing, low resolution; and (d) 8 PSS/TiO₂ bilayers on a glass substrate after annealing, high resolution.

FIG. 6A-6D shows (A) a comparison of the photoelectrochemical response for photocatalyst electrodes with different annealing temperatures; (B) a comparison of the photocurrent generated by photocatalyst electrodes with different annealing temperatures; (C) a comparison of the photocurrent generated by photocatalyst electrodes with different numbers of PSS/TiO₂ bilayers; and (D) the transmittance of 365 nm ultraviolet light through photocatalyst electrodes with different numbers of PSS/TiO₂ bilayers.

FIG. 7A-7F shows (A) relative methylene blue (MB) concentration versus irradiation time with different bias potential in a first PEC configuration; (B) MB degradation kinetics for different bias potential in a first PEC configuration; (C) the relationship between the photodegradation constant (k), current between electrodes, and bias potential in a first configuration of a PEC system; (D) relative MB concentration versus irradiation time with different bias potential in a second PEC configuration (or reverse PEC configuration); (E) MB degradation kinetics for different bias potential in a second PEC configuration; and (F) the relationship between the photodegradation constant (k), current between electrodes, and bias potential in a second configuration of a PEC system.

FIG. 8A-8C shows (A) relative Cu²⁺ concentration versus irradiation time with different PEC configurations, in which a first configuration is indicated as “PEC” and a second configuration is indicated as “Reverse-PEC”; (B) relative heavy metal ion (Cu²⁺, Pb²⁺, Cd²⁺) concentration after 2 hours deduction in PEC with a first configuration under different applied voltages; and (C) relative heavy metal ion (Cu²⁺, Pb²⁺, Cd²⁺) concentration after 2 hours deduction in PEC with a second configuration under different applied voltages.

FIG. 9A-9B shows the performance of a non-limiting microfluidic PEC system with different mass flow rates under different applied potentials on (A) MB removal and (B) heavy metal ions removal (Cd²⁺).

FIG. 10A-10D shows yet another non-limiting system for performing PEC. Provided are (A) a schematic of a non-limiting fabrication process; (B) an image of a non-limiting fabricated multilayer PEC system; and (C, D) images of a non-limiting apparatus including a multilayer PEC system, a delivery system configured to provide a fluid to the PEC system, and a radiation source configured to radiate the photocatalyst of the PEC system.

FIG. 11A-11C shows the performance of a non-limiting multilayer PEC system on (A, B) MB removal and (C) heavy metal ions removal.

### DETAILED DESCRIPTION

The present document relates to a photoelectrocatalysis system that can be used to remove contaminants. In some embodiments, the system can be employed to simultaneously remove both organic species and inorganic species (e.g., heavy metal ions) from water.

In photoelectrocatalysis, both photocatalysis and electrochemistry are used to generate useful active radicals that react with contaminants. During photocatalysis, a photocatalyst is used to generate charged carriers upon irradiation with light. In particular embodiments, the photocatalyst can include a semiconductor material characterized by a band gap energy (E_{g}, which is a difference between the valence band VB and the conduction band CB) that can be irradiated (e.g., hv≥E_{g}) to provide an electron/hole pair (e⁻/h⁺).

Such carrier pairs can be separated (e.g., by using a gradient potential) within an electrochemical cell. For example, the electrochemical cell can include a first electrode (e.g., a photoelectrode) having the photocatalyst and a second electrode (e.g., a cathode) having a conductive material. After generating the electron/hole pair, the photo-generated hole can be employed to oxidize components in proximity to the photoelectrode (e.g., to oxidize water and/or hydroxyl anions, thereby generating hydroxyl radicals), and the photo-generated electron can be delivered to the second electrode. In turn, the second electrode can be employed to reduce components in proximity to the second electrode. In conventional photoelectrocatalysis, the photoelectrode acts as the working electrode, and the cathode acts as the counter electrode.

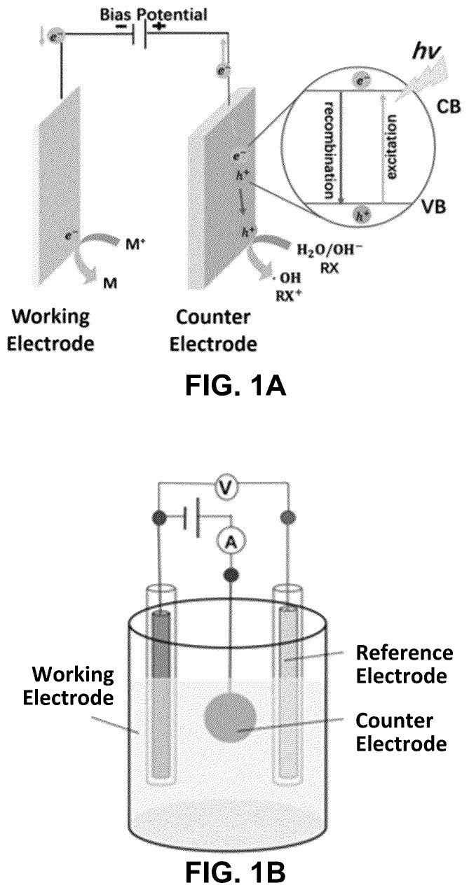

In certain non-limiting embodiments, the system can employ reverse photoelectrocatalysis. FIG. 1A shows a non-limiting schematic that employs reverse photoelectrocatalysis. As can be seen for reverse photoelectrocatalysis, the photoelectrode acts the counter electrode, and the other electrode acts as a working electrode. In particular non-limiting embodiments, a graphene oxide (GO) coated porous foam copper serves as a working electrode, and a microchannel with a photocatalyst serves as the counter electrode. In some embodiments, a negative bias potential can be applied to the working electrode to reduce the heavy metal ions, and the current flow through the circuit helps transfer the photoexcited electrons from the counter electrode (e.g., having a photocatalyst) to the working electrode (e.g., having graphite). In this configuration, inorganic heavy metal ions (e.g., M⁺ in FIG. 1A) can be reduced in proximity to the working electrode, and the photocatalytic degradation of organic contaminants (e.g., RX in FIG. 1A) on the counter electrode can be enhanced.

FIG. 1B shows a non-limiting schematic that employs reverse photoelectrocatalysis, wherein the system can include a working electrode, a counter electrode, and a reference electrode. In some embodiments, use of the reference electrode can be used to apply a potential to the working electrode, which in turn can allow for enhanced control over redox potential during use. In some embodiments, the system herein can employ a three-electrode configuration, wherein the counter electrode and working electrode are configured for reverse photoelectrocatalysis, and wherein the reference electrode is configured to control the potential of the working electrode. In some embodiments, a negative bias potential is applied between working electrode and the reference electrode. Additional details regarding photoelectrocatalysis and reverse photoelectrocatalysis systems are described herein.

### Systems

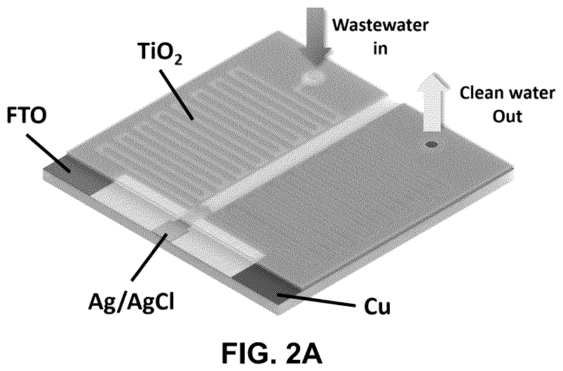

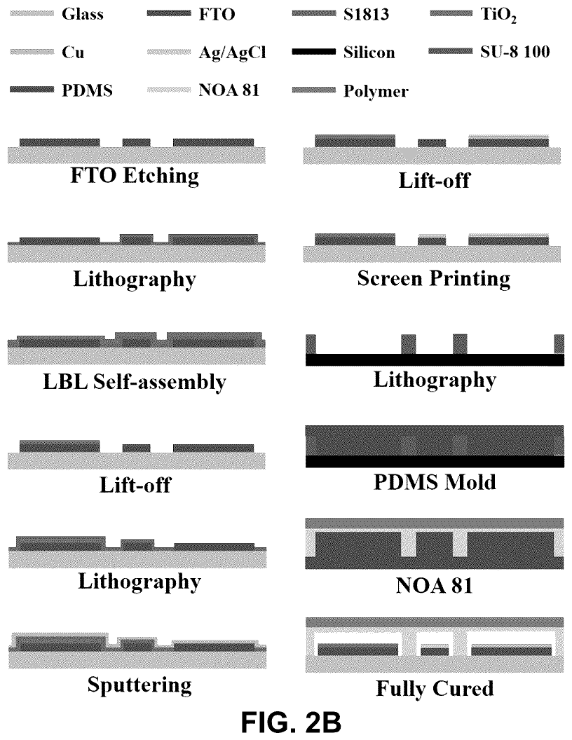

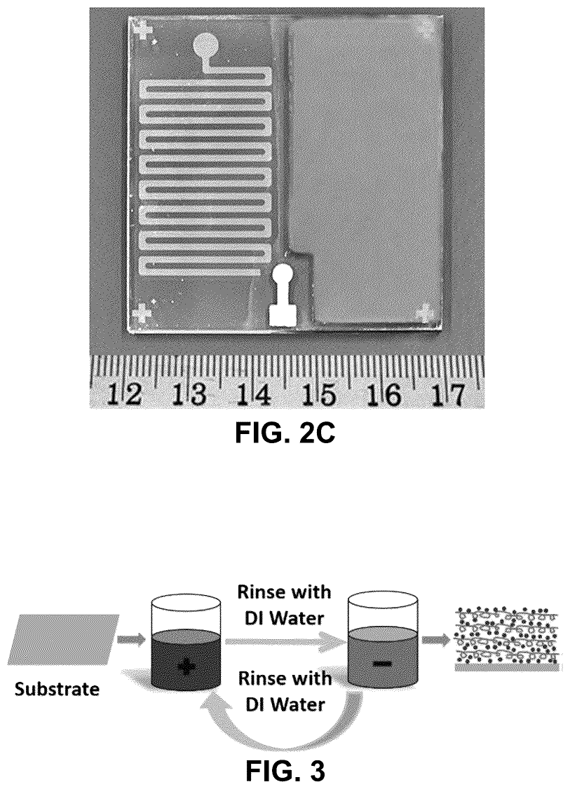

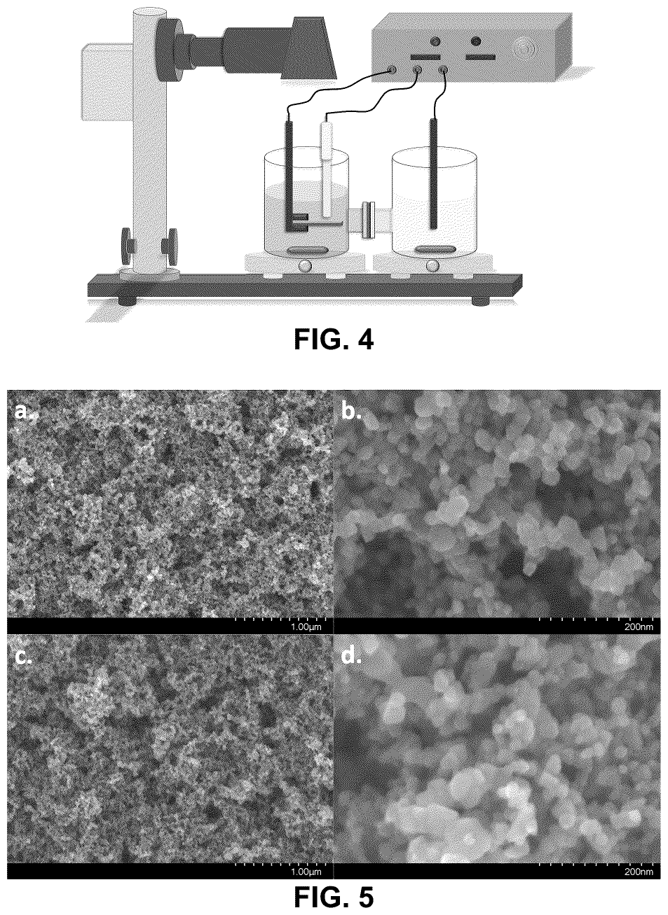

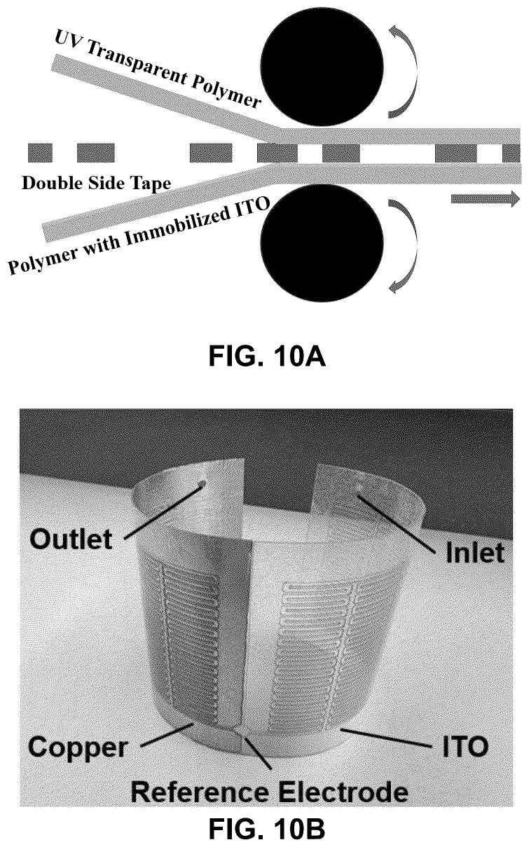

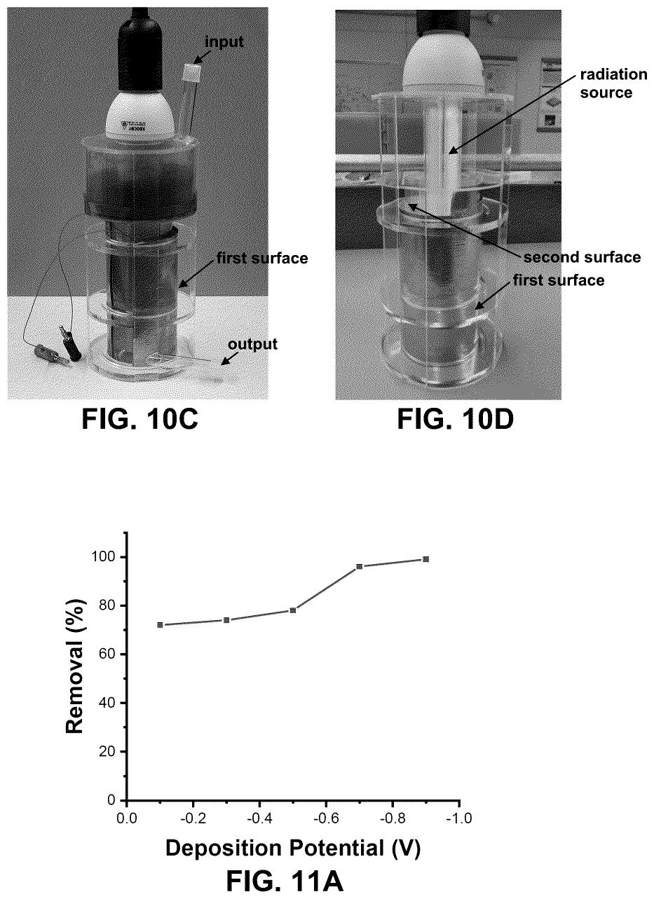

The present document encompasses photoelectrocatalysis (PEC) systems for processing a fluid (e.g., water, including contaminated water or wastewater). The system can include any combination of channels (e.g., microchannels), reactors, chambers, pumps, compressors, sensors (e.g., pH sensors, temperature sensors, etc.), mixers, filters, and the like. In some embodiments, the system employs one or more components to perform any method described herein. Non-limiting examples of systems are described in FIG. 2A-2C and FIG. 10A-10D.

In some embodiments, the system includes: a counter electrode comprising a photocatalyst (e.g., any described herein); a working electrode comprising a conductive material (e.g., any described herein); and a fluidic cell configured to provide a fluid in proximity to the counter electrode and the working electrode. In some embodiments, the system is configured to perform reverse photoelectrocatalysis.

The system can be configured to provide an applied bias potential (e.g., an applied negative bias potential) between the working electrode and the reference electrode. Non-limiting applied bias potential includes from about −0.5 to −1.0 V. The system can be configured to provide a current density between electrodes. Non-limiting current density includes from about 270 to 490 μA/cm².

The system can employ a substrate, in which the counter electrode, the working electrode, the fluidic cell, and the reference electrode, if present, can be disposed on at least a portion of a first surface (e.g., top surface) of a substrate. The substrate can include any useful material, such as tin oxide (including doped forms thereof), indium tin oxide, glass, quartz, silicon, silica, a polymer, a ceramic, as well as combinations thereof; and the substrate can have any useful form (e.g., a planar substrate, a rolled substrate, a flexible substrate, or a curved substrate). The substrate can include a film (e.g., a film roll, such as a multilayer film roll), a platen, and the like.

The electrodes can be disposed on the surface of the substrate in any useful manner, such as by photolithography, machining, etching, film deposition, thermal spraying (e.g., air plasma spraying), dip coating, spin coating, roll coating, spray coating, physical vapor deposition, chemical vapor deposition, electrodeposition, electroless deposition, anodization, chemical conversion, sol-gel deposition, spray pyrolysis, sputtering (e.g., radiofrequency planar sputtering, direct current sputtering, triode sputtering, reactive sputtering, glow discharge sputtering, and magnetron sputtering), evaporation (e.g., cathodic arc evaporation), ion plating, annealing, e-beam lithography, holography, embossing, and laser patterning, as well as combinations thereof. Optionally, any deposited material can be cured, hardened, and/or annealed.

The fluidic cell can be disposed on the surface of the substrate in any useful manner. For example and without limitation, a fluid cell can be molded or otherwise fabricated and then aligned and attached to the surface of the substrate. In another non-limiting example, the fluidic cell can be monolithically formed on the surface of the substrate.

The fluidic cell can be fabricated in any useful manner, such as by photolithography, machining, etching, film deposition, bonding, surface treatment, electron beam lithography (EBL), direct laser writing (DLW), direct laser lithography, near-field optical lithography, nanoimprint lithography (NIL), deep UV lithography (DUV), extreme UV lithography (EUV), multiphoton polymerization (MPP) lithography, dip pen lithography (DPL), scanning tunneling microscopy lithography, atomic force microscopy lithography, microstereolithography, molecular beam epitaxy (MBE), ink jet printing, electrohydrodynamic (EHD) jet printing, focused-ion-beam (FIB) milling, and the like.

The fluidic cell can be configured to provide fluid to the electrodes (e.g., counter electrode, working electrode, and/or reference electrode). In some embodiments, the fluidic cell comprises a microchannel, an inlet in fluidic communication with the microchannel and configured to deliver the fluid as an input into the microchannel, and an outlet in fluidic communication with the microchannel and configured to deliver the fluid as an output out of the microchannel.

In some embodiments, the microchannel is configured to provide fluidic communication between the counter electrode, working electrode, and/or reference electrode. In some embodiments, the counter electrode, working electrode, and/or reference electrode is disposed within the microchannel.

The system can be configured to provide any useful flow rate of fluid through the fluidic cell. Non-limiting flow rates include from about 0 to 10 mL/h.

The system can include other layers, materials, or components to facilitate photoelectrocatalysis. In some embodiments, the system includes: a polymeric layer (e.g., comprising an ultraviolet transparent polymer) disposed on at least a portion of a second surface (e.g., bottom surface) of the substrate; and an optional adhesive layer disposed between the substrate and the polymeric layer. In some embodiments, the polymeric layer is configured to receive and transmit radiation from a radiation source to the photocatalyst. In some embodiments, the adhesive layer comprises a transparent polymer (e.g., an ultraviolet transparent polymer) configured to bond the substrate to the polymeric layer. Non-limiting materials for the polymeric layer can include any described herein, such as a fluorinated polymer (e.g., fluorinated ethylene propylene (FEP)), a polystyrene, or combinations thereof (e.g., as a copolymer and/or as multilayers of such polymers).

In some embodiments, the system includes a radiation source configured to provide radiation to the photocatalyst. In some embodiments, the radiation source provides ultraviolet light (e.g., from about 10 to 400 nm or from about 280 to 400 nm).

The system can be configured to access fluid from a first surface of the system and to provide radiation to a second surface of the system. In some embodiments, the system includes: a substrate comprising a first surface (e.g., top surface) and a second surface (e.g., bottom surface) that opposes the first surface; a plurality of electrodes disposed on the first surface of the substrate; and a radiation source configured to provide radiation (e.g., ultraviolet radiation) through the second surface of the substrate. In some embodiments, the plurality of electrodes comprises: a counter electrode comprising a photocatalyst, wherein the counter electrode is disposed on at least a portion of the first surface of the substrate; a working electrode comprising a conductive material, wherein the working electrode is disposed on at least a portion of the first surface of the substrate; and/or a reference electrode disposed on at least a portion of the first surface of the substrate.

In some embodiments, the system further includes a fluidic cell disposed on at least a portion of the first surface of the substrate. The fluidic cell can be further configured to provide a fluid in proximity to the counter electrode, the working electrode, and the reference electrode. In addition, the fluidic cell can include an inlet in fluidic communication with the microchannel and configured to deliver the fluid as an input into the microchannel, wherein the inlet is configured to be accessible from the first surface of the substrate; and an outlet in fluidic communication with the microchannel and configured to deliver the fluid as an output out of the microchannel, wherein the outlet is configured to be accessible from the first surface of the substrate.

### Electrodes

The system can include one or more electrodes, which can include any useful combination of one or more counter electrodes, working electrodes, and reference electrodes.

In some embodiments, the electrode (e.g., a counter electrode) can include a photocatalyst. The photocatalyst can include a semiconductor material, which in turn can be disposed on a substrate. Examples of materials include titanium oxide (e.g., TiO₂), iron oxide (e.g., Fe₂O₃), tin oxide (e.g., SnO₂), tungsten oxide (e.g., WO₃), zinc oxide (e.g., ZnO), cadmium selenide (e.g., CdS), and the like. In some embodiments, the semiconductor material can be an n-type material. In some embodiments, the semiconductor material can be any material characterized by a band gap energy (E_{g}) that can be irradiated by a radiation source to provide an electron/hole pair. In some embodiments, the radiation source provides ultraviolet light (e.g., from about 280 to 400 nm). In some embodiments, the material is characterized by an E_{g} from about 2 eV to 4 eV.

The photocatalyst can be provided in any useful manner. For example, the photocatalyst can be provided as a film, a powder, a particle (e.g., a nanoparticle), a nanostructure, a layer (e.g., a bilayer or a multilayer), and the like. In some embodiments, the photocatalyst can include a film (e.g., a bilayer or multilayer film) formed by layer-by-layer (LBL) deposition in the presence of an anionic component (e.g., an anionic compound, such as a negatively charged polyelectrolyte or graphene; or an anionic polymer) and a cationic component (e.g., a cationic compound, such as a solution containing a positively charged polyelectrolyte or TiO₂; or a cationic polymer). In some embodiments, a semiconductor material (e.g., any herein, such as TiO₂ particles, which can include nanoparticles) can employed as a cationic component. FIG. 3 shows a schematic of a non-limiting LBL process, in which a substrate is alternately exposed to a cationic component and an anionic component. Rinse steps may conducted before or after exposure to such components. Any order may be employed, in which a cationic component can be provided first if the surface of the substrate is negatively charged or in which an anionic component can be provided first if the surface of the substrate is positively charged. Such steps (e.g., exposure to anionic components, cationic components, rinse solutions, etc.) can be conducted for any useful number of cycles.

In some embodiments, the electrode (e.g., a working electrode and/or a reference electrode) can include a conductive material. Non-limiting examples of a conductive material include an ohmic material, a metal (e.g., copper, aluminum, chromium, gold, nickel, platinum, silver, stainless steel, titanium, as well as oxides thereof, alloys thereof, and/or multilayers thereof), or a carbon material (e.g., graphene, carbon nanotubes, graphite, and the like, as well as oxides thereof and/or multilayers thereof), or a combination of any of these. In some embodiments, the conductive material comprises graphene-coated or graphene oxide-coated metal (e.g., a porous metal, such as porous copper).

The conductive material can be provided in any useful manner. For example, the conductive material can be provided as a film (e.g., a porous film), a powder, a particle (e.g., a nanoparticle), a nanostructure, a layer (e.g., a multilayer), a foam (e.g., a porous foam), and the like. Optionally, the conductive material can be disposed on a substrate.

### Contaminants

The present disclosure encompasses systems and methods for removing one or more contaminants. In some non-limiting embodiments, the removing can include removal of both organic and inorganic contaminants. Non-limiting examples of organic contaminants can include dyes, surfactants, organic solvents, pesticides, petroleum-based wastage, timber, and gas or liquid phase volatile compounds. Non-limiting examples of inorganic contaminants can include heavy metals (e.g., arsenic (As), cadmium (Cd), chromium (Cr), copper (Cu), lead (Pb), nickel (Ni), or zinc (Zn), as well as combinations thereof and/or ionic forms thereof) In some embodiments, the inorganic contaminant includes one or more metal ions (e.g., arsenic (As), cadmium (Cd), copper (Cu), lead (Pb), nickel (Ni), and the like, as well as combinations thereof). In some embodiments, the inorganic contaminant include one or more low redox potential metal ions, e.g., Cd(II).

Yet other examples of contaminants can include one or more of the following: suspended solids, organic matter, nutrients, pathogens, metals, and inorganic dissolved matter.

### EXAMPLES

### Example 1: A Photoelectrocatalysis Water Purification Configuration for Simultaneous Removal of Organic Pollutant and Heavy Metal Ions in Water

Polluted water contains various contaminants, including suspended solids, organic matter, nutrients, pathogens, metals, and inorganic dissolved matter. Technologies for water purification, such as adsorption, coagulation, sedimentation, chemical filtration, and membrane filtration, are relatively inefficient and can generate toxic secondary pollution. Photocatalytic water treatment based on photocatalysts is a promising low-cost and sustainable water treatment technology. This technology uses electron-hole pairs generated by photocatalysts under light illumination to produce active radicals that degrade organic pollutants in water. However, its efficiency can be limited by the recombination of photoexcited electrons and holes, which reduces the lifetime of photo-generated holes.

Numerous methods have been developed to prevent the recombination of electrons and holes in photocatalysts. For example, heterostructured photocatalysts can prevent electron-hole recombination by transferring photoexcited electrons from a semiconductor with a higher conduct band minimum to one with a lower conduct band minimum. Other examples include improvement of photocatalytic efficiency by doping metals, metal oxides, non-metals, or graphene onto photocatalysts to transfer photo-generated electrons. These methods can involve transferring electrons to a lower energy level, leading to the release of a portion of the potential energy of the transferred electrons and a reduced redox potential, which can limit the scope of application of photocatalysis.

Photoelectrocatalysis (PEC) is considered an effective method for addressing the recombination of electron-hole pairs in photocatalysts. PEC involves applying a bias potential to a photocatalyst to induce electron migration from the photocatalyst to another electrode, thereby achieving the separation of electron-hole pairs and enhancing the efficiency of photocatalysis. Without wishing to be limited by mechanism, applying a bias potential as low as 0.1 V can achieve 2.59 times higher photodegradation efficiency. Another benefit of PEC is the removal of heavy metal ions at the cathode due to the reducing ability of electrons in the counter electrode.

Described herein is a configuration of a three-electrode system based PEC water purification system. In particular, a photoelectrocatalytic water purification system was developed by combining photocatalysis and electrochemistry. This configuration achieves simultaneously remove both organic compounds and inorganic heavy metal ions from water by assigning the carbon electrode as the working electrode while the electrode endowed with the photocatalyst serves as the counter electrode. A negative bias potential can be imparted onto the working electrode to induce the reduction of heavy metal ions, whereas the photocatalytic degradation of organic pollutants on the counter electrode is amplified via the transfer of photoexcited electrons from the counter electrode (photocatalyst) to the working electrode. Evaluations conducted in bulk solutions demonstrated that photoelectrocatalysis surpassed photocatalysis by yielding an organic matter degradation efficiency that was 2.3 times higher, successfully degrading 98% of a 10 μM methylene blue (MB) solution within 2 hours. Simultaneously, the system realized the recovery of heavy metal ions including copper, lead, and cadmium. This photoelectrocatalytic water purification system was further integrated within microchannels, and the resultant testing data affirms the substantial potential for system miniaturization.

Described herein is a comprehensive investigation into the enhancement of water treatment efficiency through photoelectrocatalysis (PEC) compared to photocatalysis. In addition to the existing PEC water treatment configurations, alternative PEC system configurations are proposed, enabling the simultaneous removal of organic compounds and most heavy metal ions. By comparing the efficiency of the two PEC system configurations in terms of organic compound degradation and heavy metal ion recovery, both configurations demonstrate improvements in photocatalytic degradation rates. Notably, the alternative configuration achieves a 2.3-fold enhancement in the degradation rate of organic compounds at a voltage of −1.0 V. Both configurations exhibit the recovery of Cu²⁺ and Pb²⁺ ions, but the second configuration exhibits significantly higher recovery efficiency and is the only one capable of recovering Cd²⁺ ions. Finally, a demonstration using a small-scale microfluidic PEC water treatment system prototype achieves 95% organic compound degradation and over 90% heavy metal ions recovery, providing a theoretical analysis and model validation for the development of both miniaturized system and large-scale array-based high-efficiency PEC water treatment platforms. Additional details follow.

### Example 2: Non-Limiting Experimental Details

Materials and reagents: Hydrochloric acid (HCl); sodium sulphate; methylene blue; standard solutions of Cu, Pb, and Cd; poly(sodium 4-styrenesulfonate) (PSS; Mw=70,000); poly(diallyl dimethyl ammonium chloride) (PDDA; 20 wt % in water); and TiO₂ nanoparticles (P25, 30% rutile and 70% anatase phase) were obtained from Sigma-Aldrich (St. Louis, MO). All solutions are prepared with deionized water from an AmeriWater silex deionization system (Dayton, OH).

Device fabrication: Two different devices were designed and fabricated for different experiments. One of them used layer-by-layer (LBL) self-assembly to deposit TiO₂ on a 2 cm×2 cm Fluorine-doped Tin Oxide (FTO) glass as the photocatalyst electrode. One g of TiO₂ was dissolved in 100 mL of HCl solution with pH=3 to form a stable suspension (see, e.g., Zhou P & Cui T, Microsystem Technol. 2020; 26:3793-3798). Then, the cleaned FTO glass was immersed in a solution containing positively-charged conductive polymer PDDA to change its surface charge. The FTO glass with a positively charged surface was then alternately immersed in a PSS solution (providing an anionic component) and a TiO₂ solution (providing a cationic component) for 10 minutes each, followed by rinsing with deionized water to remove unbound molecules after each deposition. Photocatalyst electrodes with different number of PSS/TiO₂ bilayers were prepared by controlling the number of LBL self-assembly cycles. The electrode with the deposited photocatalyst was then placed in a furnace (MTI OTF-1200X-5L) and annealed at different temperatures. The heating rate was 2° C./min, and the final annealing temperature was maintained for 5 hours.

The integrated microfluidic-based PEC system was fabricated on a 5 cm×5 cm FTO glass. The design and fabrication process of a non-limiting PEC system are illustrated in FIG. 2A and FIG. 2B, respectively. Firstly, the FTO glass was etched into the desired shape of the three electrodes using zinc and HCl. The photocatalyst with microchannel shape was deposited on the photocatalyst electrode using a lift-off method. Initially, a positive photoresist was used to pattern the microchannel shapes on the FTO glass, and TiO₂ was deposited using the LBL self-assembly method as described herein. The photoresist was then removed by immersing the FTO glass in acetone and followed by annealing in the furnace. The heavy metal ion reduction electrode was deposited with a 100 nm thick copper film by sputtering to enhance the binding strength with the reduced heavy metal. A silver/silver chloride reference electrode was fabricated by screen printing of silver/silver chloride paste on the designed area. FIG. 2C shows a picture of non-limiting fabricated electrodes on FTO glass.

The microchannel was fabricated based on polydimethylsiloxane (PDMS) soft-lithography. The microchannel structure was first patterned on a silicon wafer using negative photoresist SU-8 100 via photolithography with a thickness of 100 μm. Next, a mold made of PDMS was created by pouring PDMS onto the silicon-based mold and curing it. The resulting PDMS mold with mating structures was then used to apply UV-curing glue (NOA81, Norland Optical Adhesive 81, Norland Products Inc., Jamesburg, NJ) on top, which was covered with a UV-transparent polystyrene polymer film. After partially curing the glue under UV illumination, the PDMS mold was replaced with the FTO glass, and more UV illumination was applied to fully cure the glue.

Measurement and characterization: The surface morphology of the photocatalyst electrode was observed using a field emission gun scanning electron microscope (FEGSEM) (Hitachi SU8230, Hitachi, Ltd., Tokyo, Japan). 2.5 nm of iridium was deposited on each sample to increase conductivity. The morphology of the deposited TiO₂ was mainly compared before and after annealing.

The photoelectrochemical response of the fabricated photocatalyst electrode was evaluated by measuring the photocurrent produced in 0.1 M sodium sulfate solution. A solar simulator was used as the light source, and an electrochemical workstation was used to measure the photocurrent. The 2 cm×2 cm photocatalyst electrode coated with TiO₂ was used as the working electrode, a graphite rod electrode was used as the counter electrode, and an Ag/AgCl electrode was used as the reference electrode.

The efficiency of photoelectrocatalytic organic degradation and heavy metal ion reduction in the PEC system was evaluated by degrading methylene blue and reducing different types of heavy metal ions. A non-limiting experimental setup is shown in FIG. 3. The two sides of an H-type electrochemical cell contained 50 mL of 0.1 M sodium sulfate solutions with 10 μM methylene blue (MB) and 1 ppm of different heavy metal ions, respectively. The two reaction chambers were separated by a proton exchange membrane (Nafion™ 117, Dupont de Nemours, Inc., Wilmington, DE). The 2 cm×2 cm photocatalyst electrode and an Ag/AgCl reference electrode were placed in the methylene blue solution, while a carbon rod was placed in the heavy metal ion solution. Every 30 minutes, 100 μL of solution was taken out from the tube and the concentration of MB was measured at 664 nm using a UV/visible spectrophotometer (model SP-UV1100, DLAB Scientific Co., Ltd, Beijing, China). The concentration of heavy metal ions was measured by inductively coupled plasma mass spectrometry (ICP-MS).

The performance of the highly integrated microfluidic-based PEC system was also evaluated by degrading MB and reducing different types of heavy metal ions. A 0.1 M sodium sulfate solution containing both 10 μM methylene blue and 1 ppm of different heavy metal ions was injected into the microchannel at different speeds, passing through the photocatalyst electrode, reference electrode, and heavy metal ions reduction electrode in sequence. The solution at the outlet was collected, and the concentrations of MB and heavy metal ions were measured.

### Example 3: Characterization and Optimization of Photocatalyst Electrodes

The morphology of immobilized photocatalysts before and after annealing was observed by SEM. FIG. 5A-5B shows the SEM images of 8 PSS/TiO₂ bilayers on a FET glass before annealing with different resolution, while FIG. 5C-5D shows the SEM images of the same sample after 500° C. annealing. The TiO₂ nanoparticles can be seen in the high-resolution images, and the size of the nanoparticles was measured about 25 nm. By comparing the SEM images before and after annealing, it can be seen that the pores in the porous structure formed by TiO₂ nanoparticles are reduced after annealing, indicating that the particles become closer to each other. Without wishing to be limited by mechanism, this may arise from the decomposition of the PDDA and PSS layers and the reorganization of the arrangement of TiO₂ nanoparticles at high temperatures. In turn, these changes may, in some non-limiting instances, contribute to enhanced binding between TiO₂ and the substrate and even to improved electron transfer between titanium dioxide nanoparticles and the substrate. Without wishing to be limited by theory, higher photocurrent and more efficient electron transfer can be provided in PEC.

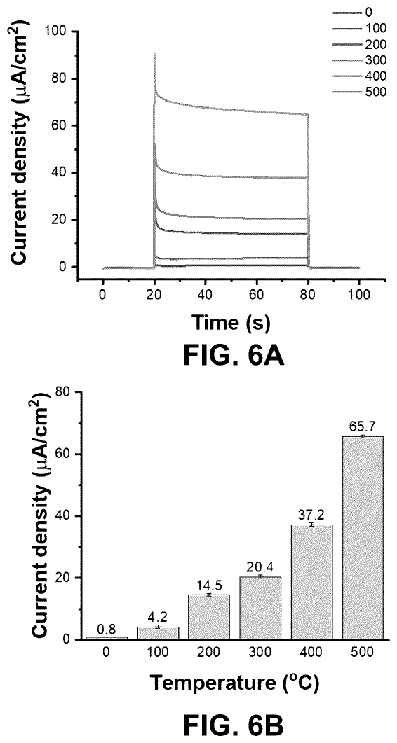

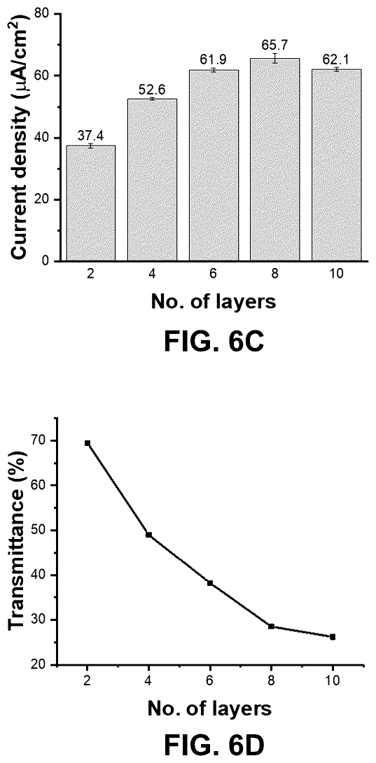

This consumption can be confirmed by measuring the photocurrent in photoelectrochemistry. FIG. 6A illustrates the photoelectrochemical response of the photocatalyst electrodes prepared at different annealing temperatures (at 100° C., 200° C., 300° C., 400° C., or 500° C.) or prepared without annealing. All the photocatalyst electrodes were coated with 8 PSS/TiO₂ bilayers via LBL self-assembly prior to annealing. The potential difference between the photocatalytic electrode and the reference electrode was maintained at 0 V. The photocatalytic electrodes were first stabilized in the dark for 20 s. Upon opening the solar light simulator, all the electrodes exhibited photocurrent, which rapidly dropped to the background current upon turning off the light. A comparison show in FIG. 6B reveals that the photocurrent density increases with increasing annealing temperature. Specifically, the electrode annealed at 500° C. for 5 hours exhibited a photocurrent that was about 82 times higher than that of the non-annealed electrode, reaching 65.7 μA/cm². Without wishing to be limited by mechanism or theory, this improvement may be attributed to the decomposition of PDDA and PSS and the rearrangement of TiO₂ nanoparticles at high temperatures.

The optimization of the number of PSS/TiO₂ bilayers coated on the photocatalyst electrode via LBL self-assembly was also evaluated through photoelectrochemical testing, and the results are presented in FIG. 6C. As shown in this figure, the photocurrent density increases as the number of PSS/TiO₂ bilayers gradually increases from 2 to 8. Without wishing to be limited by mechanism or theory, this can be attributed to the larger coverage of TiO₂ on the electrode surface, resulting in the generation of more photoexcited electrons. However, when the number of PSS/TiO₂ bilayers exceeds 8, the photocurrent density tends to saturate and even exhibit a decrease. Without wishing to be limited by mechanism or theory, this phenomenon can be explained by the results shown in FIG. 6D, which demonstrates the transparency of the prepared photocatalytic electrodes under 365 nm ultraviolet light. It can be observed that a higher number of PSS/TiO₂ bilayers leads to lower transparency, indicating a significant reduction in the light intensity received by the underlying layers of the photocatalyst. Additionally, the electrons generated by the surface-layer photocatalyst may require a longer pathway to reach the FTO surface. As seen in FIG. 6D, a decrease in photocurrent density is observed when the number of PSS/TiO₂ bilayers exceeds 8. Ultimately, 8 PSS/TiO₂ bilayers were selected for the photocatalyst electrode in further experiments described herein.

### Example 4: PEC Water Purification System

In PEC water treatment systems, the photocatalyst electrode is typically used as the anode to degrade organic pollutants by utilizing photo-generated holes. Electrodes formed from other (e.g., non-photocatalytic) materials generally serve as the cathode, where the transferred photo-generated electrons are used to reduce heavy metal ions. One non-limiting purpose of PEC is to separate the photo-generated electron-hole pairs. Therefore, when combining the photocatalyst electrode with the electrochemical three-electrode system, there are generally two different configurations.

A first configuration can involve using the photocatalyst electrode as the working electrode, where oxidation reactions occur to remove organic pollutants from water. The other electrode (formed from a non-photocatalytic material, e.g., as in a graphite rod) can be used as the counter electrode, where photo-generated electrons are transferred to undergo reduction reactions, recovering heavy metal ions from the water.

In a second configuration, the roles of the photocatalyst electrode and carbon rod are reversed, in which the graphite rod electrode serves as the working electrode and a negative potential can be applied between the working electrode and the reference electrode to reduce heavy metal ions. Here, the photocatalyst electrode functions as the counter electrode, still generating oxidation reactions through photo-generated holes. This second configuration can be referred to undergoing reverse photoelectrocatalysis.

As used herein, “photoelectrocatalysis” and “PEC” are general terms used to refer to any useful configuration of electrodes to promote both photocatalysis and electrochemistry. Both the first and second configurations are considered to undergo photoelectrocatalysis in a general sense.

Both the first and second configurations can enable the transfer of photo-generated electrons from the photocatalyst electrode to the graphite rod electrode. The following experiments compare the differences between the two configurations in terms of organic pollutant degradation and heavy metal ion reduction.

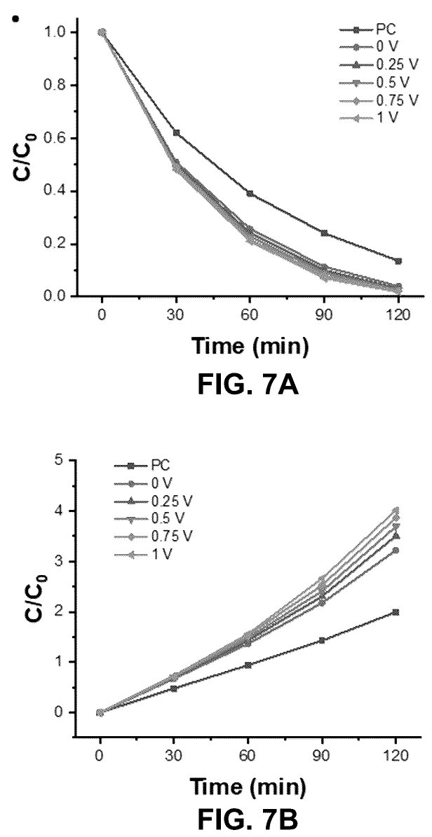

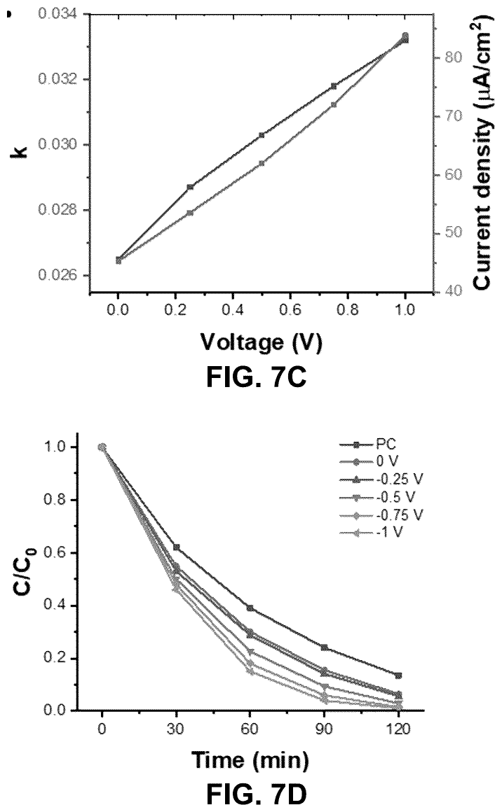

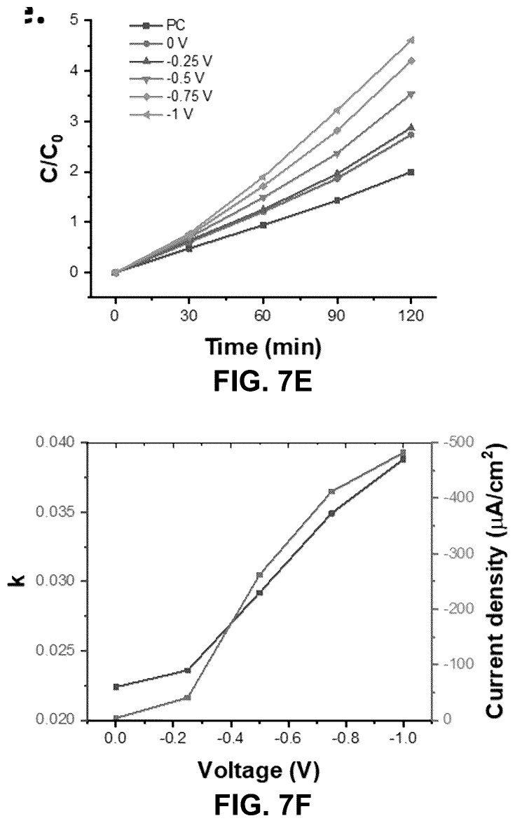

The efficiency of PEC system for the degradation of organic compounds was evaluated through the degradation of MB solution. MB degradation was tested under different electrode potentials in two configurations, and the concentration changes are shown in FIG. 7A and FIG. 7D. The concentration of MB continuously decreased with increasing illumination time. The lower the concentration of MB, the slower the rate of concentration change, and the photodegradation kinetics of MB can be described by a first-order kinetic equation:³⁰

In(C/C₀)=kt

where C and Co are the MB concentrations at the beginning and during light illumination, respectively; t is time; and k is the reaction rate constant, which can be used to represent the photodegradation efficiency. Therefore, the slopes in FIG. 7B and FIG. 7E indicate the photodegradation efficiency corresponding to the two configurations.

Pure photocatalysis without the introduction of the PEC system was used for comparison to demonstrate the enhancement of photodegradation efficiency for organic compound by the two different PEC systems. It can be observed that when the photocatalyst electrode served as the working electrode (FIG. 7A-7B), the PEC system displayed a twofold increase in photodegradation efficiency compared to pure photocatalysis at a working electrode potential of 1.0 V. When the graphite rod served as the working electrode (FIG. 7C-7D), the PEC system exhibited a maximum photodegradation efficiency that was 2.3 times higher than that of pure photocatalysis.

It is also noted that when the photocatalyst electrode served as the working electrode, a significant improvement in photocatalytic degradation efficiency could be achieved even at a relatively low voltage, whereas in the other configuration, the enhancement of photocatalytic efficiency was clearly dependent on the working electrode potential. Without wishing to be limited by theory, this may be due to the different variations in current magnitude with respect to the working electrode potential in different configurations, as shown in FIG. 7C and FIG. 7F. When the photocatalyst electrode served as the working electrode, the current in the system originates from the photocurrent and the redox current at the working electrode. Since the photocurrent is much larger than the redox current and is not affected by the electrode potential, significant current can be generated at low electrode potentials, enabling the efficient separation of photogenerated electron-hole pairs and leading to a notable improvement in photocatalytic degradation efficiency. On the other hand, when the graphite rod serves as the working electrode, the current in the PEC system is determined mainly by the heavy metal ions reduction current of on the graphite rod electrode. This current magnitude is dependent on the electrode potential. When the electrode potential becomes more negative (larger in absolute value), the reduction reaction on the electrode becomes more vigorous, resulting in a larger current. When the consumption rate of electrons on the working electrode is lower than the rate of photogenerated electron production on the photocatalyst electrode, only a partial separation of photogenerated electron-hole pairs occurs, leading to a smaller improvement in photocatalytic degradation efficiency. However, when the potential on the working electrode becomes negative enough to generate an electron consumption rate exceeding the number of photogenerated electrons, the counter electrode potential can rapidly increase to facilitate additional electrochemical degradation of organic compounds, generating sufficient electrons. In this non-limiting scenario, a higher enhancement in photocatalytic degradation rate can be observed compared to the previous configuration.

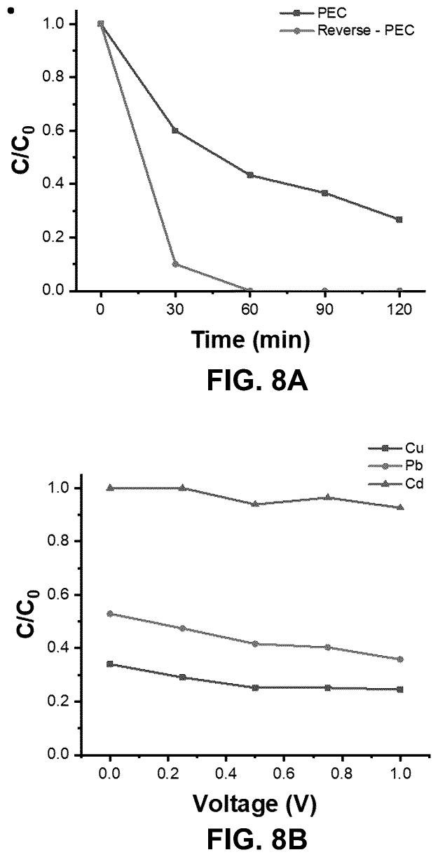

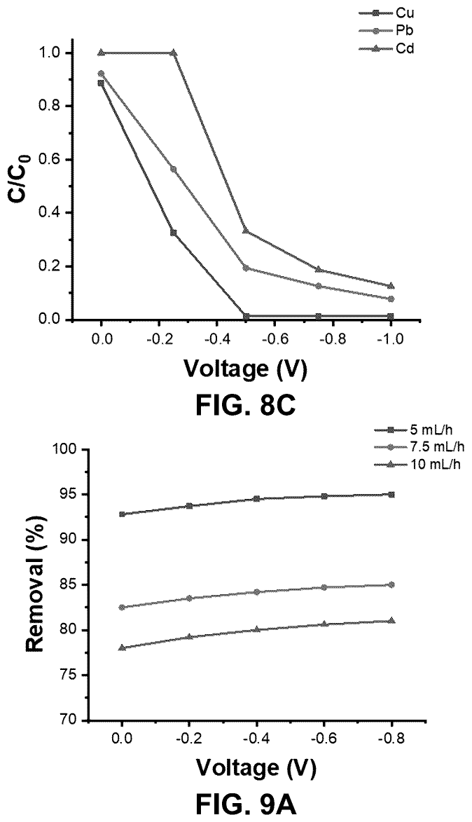

The two different configurations of the PEC system exhibit more significant differences in the reduction of heavy metal ions. FIG. 8A records the reduction of copper ions (Cu²⁺) in the two PEC system configurations when the absolute value of the working electrode potential is 1.0 V. It can be observed that in the second configuration (indicated as “Reverse-PEC”) with the graphite rod as the working electrode, the concentration of Cu²⁺ rapidly decreases and is completely recovered within one hour. In contrast, when the photocatalyst electrode serves as the working electrode, only 72% of Cu²⁺ are recovered within 2 hours. This phenomenon can also be explained by the current changes in FIG. 7C and FIG. 7F. It can be seen that when the absolute value of the working electrode potential is 1.0 V, the current density in the second configuration (with the graphite rod as the working electrode) is much higher than the current density when the photocatalyst electrode serves as the working electrode, and a higher current density implies a faster reduction of heavy metal ions.

The reduction effects of different heavy metal ions were compared in the two different configurations of PEC systems. In addition to Cu²⁺, the reduction of lead (Pb²⁺) and cadmium (Cd²⁺) ions was also tested. FIG. 8B-8C show the concentrations of heavy metal ions in the solution after 2 hours of operation of the PEC systems. It can be observed that the first configuration of the PEC system cannot reduce Cd²⁺, and its reduction efficiency for Cu²⁺ and Pb²⁺ is also low, with no significant changes observed with increasing electrode potential. Without wishing to be limited by mechanism or theory, this may arise because the number of photo-generated electrons is limited, and the absolute value of the photo-generated electron potential is much lower than the redox potential of Cd²⁺. In the second configuration for the PEC system, reduction of all three heavy metal ions can be observed, and the efficiency of heavy metal ion reduction increases with more negative electrode potential. In particular, reduction of Cd²⁺ can be observed when the working electrode potential is lower than the redox potential of Cd²⁺, which cannot be achieved with the first configuration of the PEC system.

### Example 5: PEC Microfluidic Water Purification System

The second PEC configuration (or reverse PEC configuration) was integrated with a microfluidic system to form a miniaturized, on-chip, efficient PEC water treatment system. This second PEC configuration was implemented during testing, where the photocatalyst electrode served as the counter electrode and the Cu electrode served as the working electrode. A mixed solution containing the organic compound MB and inorganic heavy metal ions was passed through the microchannel at flow rates of 5 mL/h, 7.5 mL/h, and 10 mL/h, respectively. The concentrations of MB and heavy metal ions at the outlet were collected and measured. To prevent the reduction reaction of MB during its passage through the working electrode from affecting the assessment of photocatalytic degradation efficiency, the obtained solution was stirred overnight under magnetic stirring, allowing the reduced MB to be oxidized by oxygen in the air and regenerating MB.

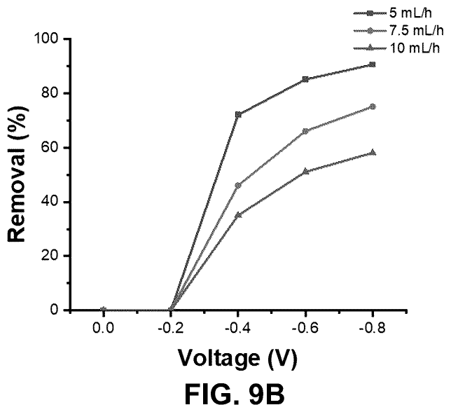

FIG. 9A illustrates the efficiency of the microfluidic photoelectrochemical (PEC) system in degrading the organic compound MB at different flow rates when the potential of the working electrode decreases from 0 V to −0.8 V. The results indicate an inverse relationship between the removal rate of MB and the flow rate. Without wishing to be limited by mechanism or theory, this phenomenon can be attributed to the shorter residence time of the solution in the microchannel at higher flow rates, leading to a shorter duration of the degradation reaction. Additionally, it is noted that as the potential of the working electrode decreases, the removal rate of the organic compound increases. Without wishing to be limited by mechanism or theory, this can be explained by the acceleration of the reduction reaction on the working electrode at lower potentials, which enhances the electron transfer rate and facilitates efficient charge separation of photogenerated electrons and holes.

Similarly, FIG. 9B demonstrates the efficiency of the microfluidic PEC system in recovering heavy metal ions. The effect of the flow rate on the reduction efficiency is similar to that of organic compound degradation. However, it is noted that working electrode potential has a more significant influence on the efficiency of heavy metal ion recovery. Potentials higher than −0.2V are insufficient for the reduction of Cd²⁺, whereas a decrease in potential below −0.4 leads to a rapid increase in recovery efficiency. In summary, when the potential of the working electrode is set at −0.8V, the system achieves over 95% degradation of 10 μM MB solution and over 90% degradation of a Cd ion solution with a concentration of 1 ppm at a flow rate of 5 mL/h.

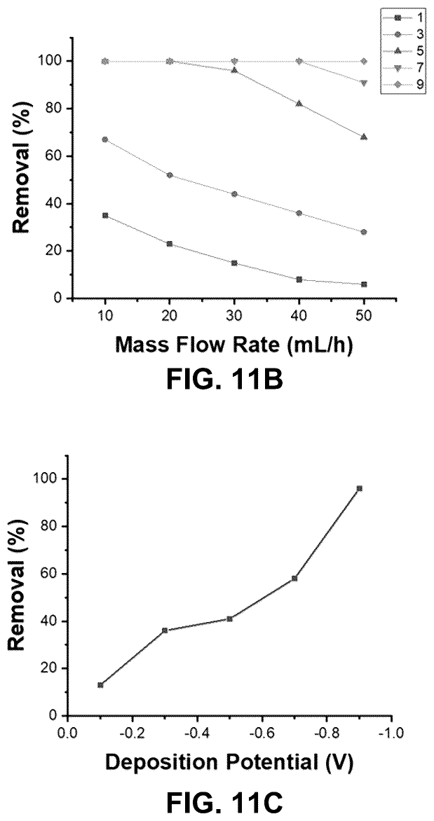

FIG. 10A-10D and FIG. 11A-11C describe another non-limiting large scale microfluidic PEC system. A non-limiting fabrication method and a non-limiting image of the fabricated channel are shown in FIG. 10A and FIG. 10B, respectively. The microchannel can be fabricated with the roll-to-roll technique. The structure of the microfluidic channel can be first fabricated on double-sided tape by laser cutting, thereby providing a channel layer. Then, the two polymer sheets can be used to cover both sides of the channel layer to form the sealed microchannel. All operations can be carried out on a roller (e.g., a 10 cm diameter roller) to reduce the internal stress after bending. The photocatalyst can be deposited on the channel surface (e.g., a first portion of the channel surface) with a layer-by-layer self-assembly technique, and half of the microchannel (e.g., on a second portion of the channel surface) can be covered with a conductive material (e.g., a thin layer of copper foil or other metal) to serve as the electrode for electrochemical deposition. FIG. 10C-10D shows images of a non-limiting standard size prototype. It can include a radiation source (e.g., a UV lamp), an optional chamber with active carbon, and a microfluidic device with immobilized photocatalyst and conductive material (e.g., copper foil).

The system shows the ability to remove methylene blue and copper ions (e.g., Cu²⁺). Different numbers of TiO₂ layers ranging from 1 to 9 were deposited in the microchannel, and the mass flow rate ranging from 10 mL/h to 50 mL/h was applied for the experiment. 10 μM methylene blue was used as an example of the organic pollutants. The concentration of methylene blue in the outlet solution was measured by spectrophotometer, and the result is shown in FIG. 11A. Complete removal of methylene blue at 50 mL/h occurs when 9 layers of methylene blue were deposited. FIG. 11B also shows the effect of mass flow rate on methylene blue removal. The lower mass flow rate means a longer residence time of solution in the microchannels and thus results in a higher removal rate with different number of TiO₂ layers. The complete removal of methylene blue can also be achieved with 7 layers of methylene blue and a mass flow rate of 20 mL/h.

The efficiency of heavy metal reduction was then studied by measuring the concentration of Cu²⁺ at the outlet, and the results are provided in FIG. 11C. Without wishing to be limited by mechanism or theory, it can be inferred from the result that lower deposition potential leads to a higher removal rate of Cu²⁺. As a result, 96% of the Cu²⁺ can be removed from the water when the mass flow rate is 50 mL/h.

Whilst the invention has been disclosed in particular embodiments, it will be understood by those skilled in the art that certain substitutions, alterations and/or omissions may be made to the embodiments without departing from the spirit of the invention. Accordingly, the foregoing description is meant to be exemplary only, and should not limit the scope of the invention. All references (including those listed above), scientific articles, patent publications, and any other documents cited herein are hereby incorporated by reference for the substance of their disclosure.

1. A system for removing one or more contaminants, the system comprising:
a counter electrode comprising a photocatalyst;
a working electrode comprising a conductive material; and
a fluidic cell configured to provide a fluid in proximity to the counter electrode and the working electrode,
wherein the system is configured to perform reverse photoelectrocatalysis.

2. The system of claim 1, wherein the photocatalyst comprises titanium dioxide.

3. The system of claim 2, wherein the titanium dioxide is provided within a layer (e.g., a single layer, a bilayer, or a multilayer) further comprising a polymer (e.g., an anionic polymer).

4. The system of claim 3, wherein the photocatalyst comprises a plurality of layers (e.g., 1, 2, 3, 4, 5, 6, 7, 8, 9, 10, or more layers) or a plurality of bilayers (e.g., 1, 2, 3, 4, 5, or more bilayers, wherein a first layer of the bilayer comprises titanium dioxide and a second layer of the bilayer comprises a polymer).

5. The system of claim 1, wherein the working electrode comprises graphene, graphene oxide, graphite, or graphite oxide (e.g., a graphene oxide-coated metal).

6. The system of claim 1, wherein the fluidic cell comprises a microchannel, an inlet in fluidic communication with the microchannel and configured to deliver the fluid as an input into the microchannel, and an outlet in fluidic communication with the microchannel and configured to deliver the fluid as an output out of the microchannel; and wherein the counter electrode is disposed within the microchannel.

7. The system of claim 6, wherein the microchannel is configured to provide fluidic communication between the counter electrode and the working electrode.

8. The system of claim 1, further comprising a reference electrode, wherein the system is configured to provide an applied potential (e.g., an applied negative potential) between the working electrode and the reference electrode.

9. The system of claim 1, wherein the counter electrode, the working electrode, the fluidic cell, and the reference electrode, if present, is disposed on at least a portion of a first surface of a substrate (e.g., a flexible substrate or a curved substrate).

10. The system of claim 9, further comprising:
a polymeric layer (e.g., comprising fluorinated ethylene propylene polymer or polystyrene polymer) disposed on at least a portion of a second surface of the substrate,
wherein the second surface opposes the first surface; and
an optional adhesive layer disposed between the substrate and the polymeric layer.

11. A system for removing one or more contaminants, the system comprising:
a substrate comprising a first surface and a second surface that opposes the first surface;
a counter electrode comprising a photocatalyst, wherein the counter electrode is disposed on at least a portion of the first surface of the substrate;
a working electrode comprising a conductive material, wherein the working electrode is disposed on at least a portion of the first surface of the substrate;
a reference electrode disposed on at least a portion of the first surface of the substrate;
a fluidic cell disposed on at least a portion of the first surface of the substrate, wherein the fluidic cell is configured to provide a fluid in proximity to the counter electrode, the working electrode, and the reference electrode; and
a radiation source configured to provide radiation (e.g., from about 280 to 400 nm) to the photocatalyst (e.g., through the first surface or the second surface of the substrate),
wherein the system is configured to perform reverse photoelectrocatalysis.

12. The system of claim 11, wherein the fluidic cell comprises a microchannel, an inlet in fluidic communication with the microchannel and configured to deliver the fluid as an input into the microchannel, and an outlet in fluidic communication with the microchannel and configured to deliver the fluid as an output out of the microchannel; and wherein the counter electrode, the working electrode, and the reference electrode are disposed within the microchannel.

13. The system of claim 11, further comprising:
a polymeric layer (e.g., comprising an ultraviolet transparent polymer) disposed on at least a portion of the second surface of the substrate, wherein the polymeric layer is configured to receive and transmit radiation from the radiation source to the photocatalyst; and
an optional adhesive layer disposed between the substrate and the polymeric layer.

14. A method for treating a contaminated fluid, the method comprising:
subjecting the contaminated fluid to reverse photoelectrocatalysis by employing a counter electrode comprising a photocatalyst and a working electrode comprising a conductive material,
thereby removing at least one organic contaminant and at least one inorganic contaminant from the contaminated fluid.

15. The method of claim 14, wherein said subjecting comprises:
delivering the contaminated fluid to a counter electrode comprising a photocatalyst, a working electrode comprising a conductive material, and an optional reference electrode.

16. The method of claim 15, wherein said subjecting further comprises (e.g., after said delivering):
providing an applied potential (e.g., an applied negative potential) between the working electrode and the reference electrode.

17. The method of claim 15, wherein said delivering further comprises providing the contaminated fluid to a microchannel, and wherein the counter electrode is disposed within the microchannel.

18. The method of claim 17, wherein the microchannel is configured to provide fluidic communication between the counter electrode, the working electrode, and the reference electrode.

19. The method of claim 15, wherein the photocatalyst comprises titanium dioxide.

20. The method of claim 19, wherein the titanium dioxide is provided within a bilayer further comprising a polymer (e.g., an anionic polymer).

21. The method of claim 15, wherein the working electrode comprises graphene, graphene oxide, graphite, or graphite oxide (e.g., a graphene oxide-coated metal).

22. The method of claim 14, wherein the at least one organic contaminant comprises a dye.

23. The method of claim 14, wherein the at least one inorganic contaminant comprises a metal or a metal ion.

24. The method of claim 23, wherein the metal or the metal ion comprises a heavy metal or a heavy metal ion.

25. A method for treating a contaminated fluid, the method comprising:
subjecting the contaminated fluid to reverse photoelectrocatalysis, wherein said subjecting is performed in a system of claim 1, thereby removing at least one organic contaminant and at least one inorganic contaminant from the contaminated fluid.
